(19) United States
(12) Patent Application Publication
(10) Pub. No.: US 2024/0429986 A1
(43) Pub. Date: Dec. 26, 2024

(54) ACKNOWLEDGMENT FOR PANEL INFORMATION REPORTING

(71) Applicant: QUALCOMM Incorporated, San Diego, CA (US)

(72) Inventors: Tianyang BAI, Mountain View, CA (US); Yan ZHOU, San Diego, CA (US); Peter GAAL, San Diego, CA (US); Fang YUAN, Beijing (CN); Konstantinos DIMOU, New York, NY (US); Tao LUO, San Diego, CA (US); Junyi LI, Greentown, PA (US)

(21) Appl. No.: 18/707,028

(22) PCT Filed: Jan. 7, 2022
(86) PCT No.: PCT/CN2022/070689

§ 371 Date: May 2, 2024

(51) Int. Cl. H04B 7/06; H04L 1/00; H04L 1/1867

(52) U.S. Cl. CPC H04B 7/0626; H04L 1/0027; H04L 1/1896

(57) ABSTRACT

Various aspects of the present disclosure generally relate to wireless communication. In some aspects, a user equipment (UE) may transmit, to a base station, a capability value set list identifying one or more capability sets. The UE may transmit, to the base station, a channel state information (CSI) report that includes a capability set identifier identifying a capability set of the one or more capability sets of the capability value set list. The UE may receive a feedback message indicating whether the base station successfully received the CSI report and whether to retransmit information identifying the capability set identifier. Numerous other aspects are described.

### FIELD OF THE DISCLOSURE

Aspects of the present disclosure generally relate to wireless communication and to techniques and apparatuses for acknowledgment for a panel information report.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Tenn Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include transmitting, to a base station, a capability value set list identifying one or more capability sets. The method may include transmitting, to the base station, a channel state information (CSI) report that includes a capability set identifier identifying a capability set of the one or more capability sets of the capability value set list. The method may include receiving a feedback message indicating whether the base station successfully received the CSI report and whether to retransmit information identifying the capability set identifier.

Some aspects described herein relate to a method of wireless communication performed by a base station. The method may include receiving, from a UE, a capability value set list identifying one or more capability sets. The method may include monitoring for a CSI report, from the UE, that includes a capability set identifier identifying a capability set of the one or more capability sets of the capability value set list. The method may include transmitting a feedback message indicating whether the CSI report is successfully received and whether to retransmit information identifying the capability set identifier.

Some aspects described herein relate to a UE for wireless communication. The UE may include a memory and one or more processors coupled to the memory. The one or more processors may be configured to transmit, to a base station, a capability value set list identifying one or more capability sets. The one or more processors may be configured to transmit, to the base station, a CSI report that includes a capability set identifier identifying a capability set of the one or more capability sets of the capability value set list. The one or more processors may be configured to receive a feedback message indicating whether the base station successfully received the CSI report and whether to retransmit information identifying the capability set identifier.

Some aspects described herein relate to a base station for wireless communication. The base station may include a memory and one or more processors coupled to the memory. The one or more processors may be configured to receive, from a UE, a capability value set list identifying one or more capability sets. The one or more processors may be configured to monitor for a CSI report, from the UE, that includes a capability set identifier identifying a capability set of the one or more capability sets of the capability value set list. The one or more processors may be configured to transmit a feedback message indicating whether the CSI report is successfully received and whether to retransmit information identifying the capability set identifier.

Some aspects described herein relate to a non-transitory computer-readable medium that stores a set of instructions for wireless communication by a UE. The set of instructions, when executed by one or more processors of the UE, may cause the UE to transmit, to a base station, a capability value set list identifying one or more capability sets. The set of instructions, when executed by one or more processors of the UE, may cause the UE to transmit, to the base station, a CSI report that includes a capability set identifier identifying a capability set of the one or more capability sets of the capability value set list. The set of instructions, when executed by one or more processors of the UE, may cause the UE to receive a feedback message indicating whether the base station successfully received the CSI report and whether to retransmit information identifying the capability set identifier.

Some aspects described herein relate to a non-transitory computer-readable medium that stores a set of instructions for wireless communication by a base station. The set of instructions, when executed by one or more processors of the base station, may cause the base station to receive, from a UE, a capability value set list identifying one or more capability sets. The set of instructions, when executed by one or more processors of the base station, may cause the base station to monitor for a CSI report, from the UE, that includes a capability set identifier identifying a capability set of the one or more capability sets of the capability value set list. The set of instructions, when executed by one or more processors of the base station, may cause the base station to transmit a feedback message indicating whether the CSI report is successfully received and whether to retransmit information identifying the capability set identifier.

Some aspects described herein relate to an apparatus for wireless communication. The apparatus may include means for transmitting, to a base station, a capability value set list identifying one or more capability sets. The apparatus may include means for transmitting, to the base station, a CSI report that includes a capability set identifier identifying a capability set of the one or more capability sets of the capability value set list. The apparatus may include means for receiving a feedback message indicating whether the base station successfully received the CSI report and whether to retransmit information identifying the capability set identifier.

Some aspects described herein relate to an apparatus for wireless communication. The apparatus may include means for receiving, from a UE, a capability value set list identifying one or more capability sets. The apparatus may include means for monitoring for a CSI report, from the UE, that includes a capability set identifier identifying a capability set of the one or more capability sets of the capability value set list. The apparatus may include means for transmitting a feedback message indicating whether the CSI report is successfully received and whether to retransmit information identifying the capability set identifier.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of physical channels and reference signals in a wireless network, in accordance with the present disclosure.

FIG. 4 is a diagram illustrating an example associated with acknowledgment signaling for panel information reporting, in accordance with the present disclosure.

FIGS. 5-6 are diagrams illustrating example processes associated with acknowledgment signaling for panel information reporting, in accordance with the present disclosure.

FIGS. 7-8 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

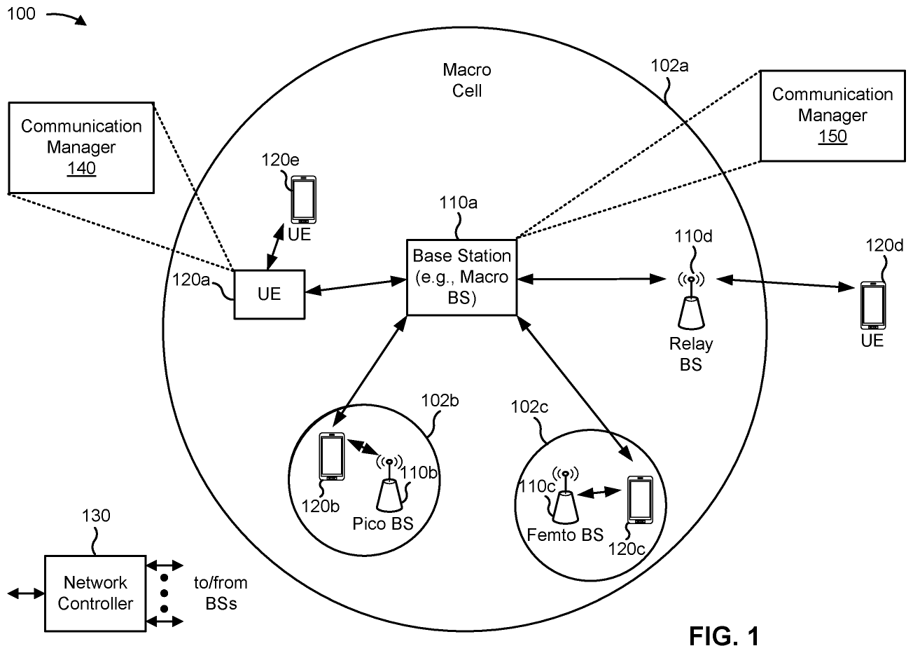

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of abase station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit, to a base station, a capability value set list identifying one or more capability sets; transmit, to the base station, a channel state information (CSI) report that includes a capability set identifier identifying a capability set of the one or more capability sets of the capability value set list; and receive a feedback message indicating whether the base station successfully received the CSI report and whether to retransmit information identifying the capability set identifier. Additionally, or alternatively, the communication manager 140 may perform one or more other operations described herein.

In some aspects, the base station 110 may include a communication manager 150. As described in more detail elsewhere herein, the communication manager 150 may receive, from a UE, a capability value set list identifying one or more capability sets; monitor for a CSI report, from the UE, that includes a capability set identifier identifying a capability set of the one or more capability sets of the capability value set list; and transmit a feedback message indicating whether the CSI report is successfully received and whether to retransmit information identifying the capability set identifier. Additionally, or alternatively, the communication manager 150 may perform one or more other operations described herein.

As indicated above, FIG. 1 is provided as an example. Other examples may differ from what is described with regard to FIG. 1.

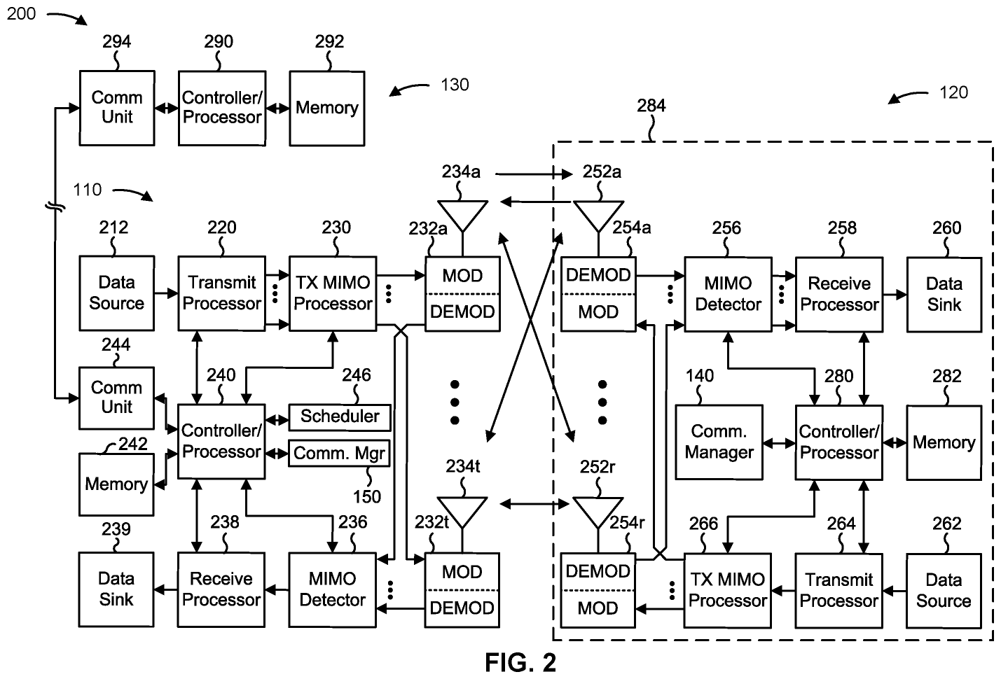

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

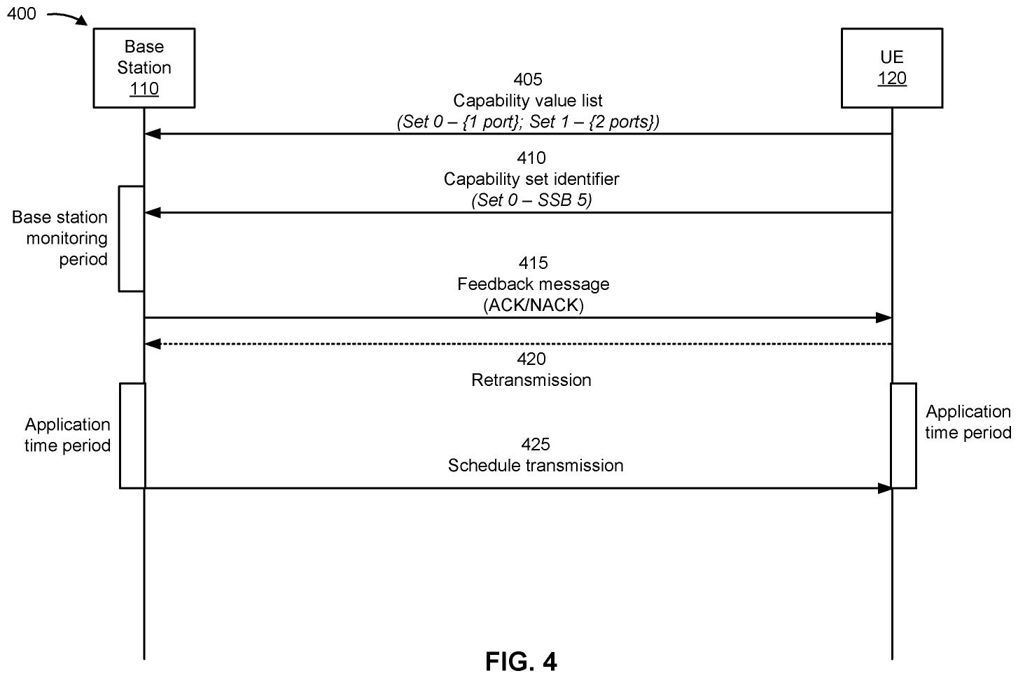

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-8).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-8).

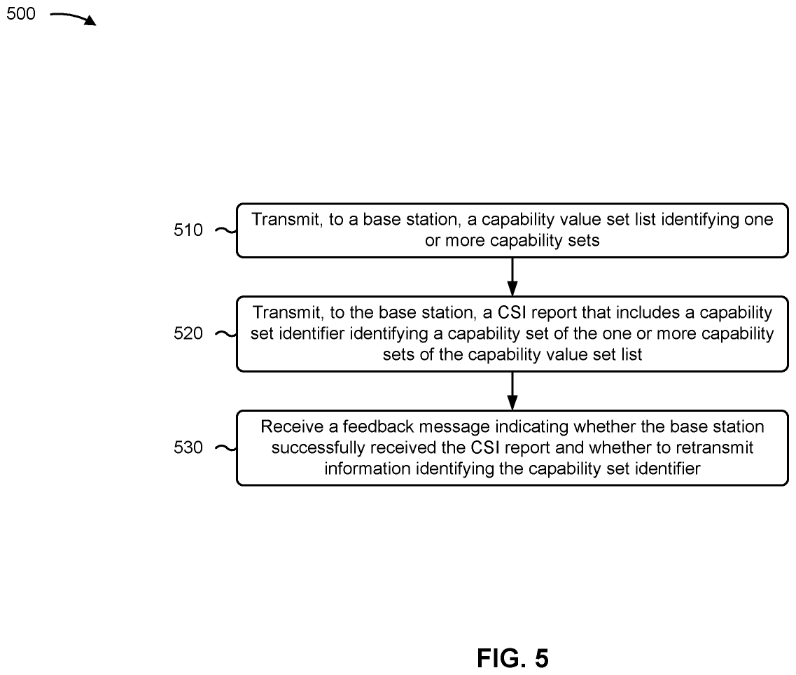

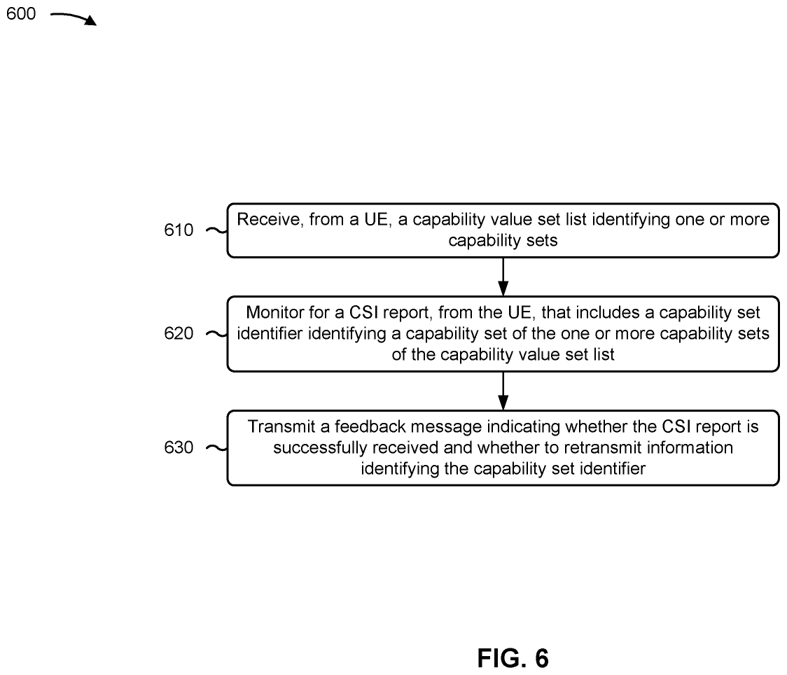

The controller/processor 240 of the base station 110, the controller/processor 280 of the UE 120, and/or any other component(s) of FIG. 2 may perform one or more techniques associated with acknowledgment signaling for panel information reporting, as described in more detail elsewhere herein. For example, the controller/processor 240 of the base station 110, the controller/processor 280 of the UE 120, and/or any other component(s) of FIG. 2 may perform or direct operations of, for example, process 500 of FIG. 5, process 600 of FIG. 6, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5, process 600 of FIG. 6, and/or other processes as described herein. In some examples, executing instructions may include running the instructions, converting the instructions, compiling the instructions, and/or interpreting the instructions, among other examples.

In some aspects, the UE 120 includes means for transmitting, to a base station, a capability value set list identifying one or more capability sets; means for transmitting, to the base station, a CSI report that includes a capability set identifier identifying a capability set of the one or more capability sets of the capability value set list; and/or means for receiving a feedback message indicating whether the base station successfully received the CSI report and whether to retransmit information identifying the capability set identifier. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station 110 includes means for receiving, from a UE, a capability value set list identifying one or more capability sets; means for monitoring for a CSI report, from the UE, that includes a capability set identifier identifying a capability set of the one or more capability sets of the capability value set list; and/or means for transmitting a feedback message indicating whether the CSI report is successfully received and whether to retransmit information identifying the capability set identifier. The means for the base station 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

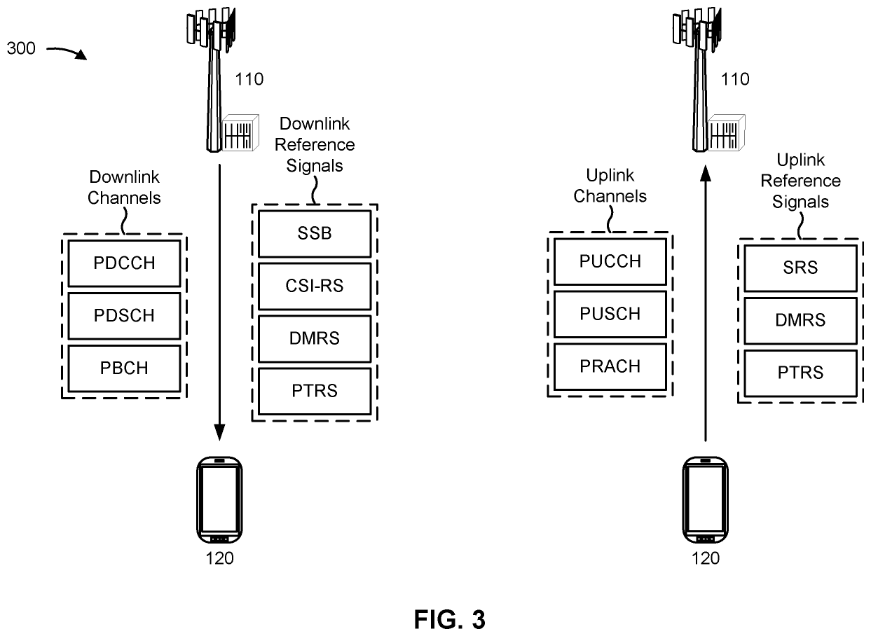

FIG. 3 is a diagram illustrating an example 300 of physical channels and reference signals in a wireless network, in accordance with the present disclosure. As shown in FIG. 3, downlink channels and downlink reference signals may carry information from a base station 110 to a UE 120, and uplink channels and uplink reference signals may carry information from a UE 120 to a base station 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit acknowledgment (ACK) or negative acknowledgment (NACK) feedback (e.g., ACK/NACK feedback or ACK/NACK information) in UCI on the PUCCH and/or the PUSCH. One type of feedback is hybrid automatic repeat request (HARQ) feedback, which may be conveyed in UCI or DCI when transmitted by a UE or base station, respectively.

As further shown, a downlink reference signal may include a synchronization signal block (SSB), a channel state information (CSI) reference signal (CSI-RS), a demodulation reference signal (DMRS), a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. The base station 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The base station 110 may configure a set of CSI-RSs for the UE 120, and the UE 120 may measure the configured set of CSI-RSs. Based at least in part on the measurements, the UE 120 may perform channel estimation and may report channel estimation parameters to the base station 110 (e.g., in a CSI report), such as a channel quality indicator (CQI), a precoding matrix indicator (PMI), a CSI-RS resource indicator (CRI), a layer indicator (LI), a rank indicator (RI), a reference signal received power (RSRP) (e.g., a layer 1 (L1) RSRP), or a signal-to-interference-and-noise ratio (SINR)), among other examples. The base station 110 may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CAPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the base station 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring base stations in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the base station 110 may then calculate a position of the UE 120 based on the RSTD measurements reported by the UE 120.

An SRS may carry information used for uplink channel estimation, which may be used for scheduling, link adaptation, precoder selection, or beam management, among other examples. The base station 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The base station 110 may measure the SRSs, may perform channel estimation based at least in part on the measurements, and may use the SRS measurements to configure communications with the UE 120.

As indicated above, FIG. 3 is provided as an example. Other examples may differ from what is described with regard to FIG. 3.

A UE may transmit a capability value list or capability value set to enable communication configuration. Elements in the capability value list may identify a maximum supported quantity of SRS ports that the UE may use for a particular UE antenna panel or spatial filter. For example, the UE may report a capability value list of ‘{0, 1, 2}’ for the maximum supported SRS ports for different UE panels, where a capability value of ‘0 port’ indicates the panel can be used for DL reception only. After transmitting the capability value list, the UE may transmit a report that includes a capability set identifier. For example, the UE may transmit information identifying the capability set identifier with a CSI-RS resource indicator (CRI), an SSB indicator (SSBI), a layer 1 (L1) reference signal received power (RSRP), or a signal-to-interference-and-noise ratio (SINR), among other examples in a L1 beam report occasion.

In some cases, the UE may provide the capability set identifier in a beam report to indicate a capability set corresponding to a port associated with a reference signal. For example, the UE may indicate a particular capability set to correspond to a uplink (UL) transmission with a UL spatial filter (e.g., a UL transmission configuration indicator (TCI) state) that is associated with a particular SSB in the beam report. In a CSI report, more than one CRI or SSBI can be reported. In such a case, two options for the UE to report a capability value set identifiers (IDs) include the UE reporting one capability value set ID for all the reported CRIs/SSBIs in a CSI report or the UE reporting one capability value set ID for each reported CRI/SSBI in the CSI report. Additionally, the UE may further report to a base station which of the aforementioned reporting options is supported by using a UE capability indicator.

Different types of base station behavior may be possible after receiving the report that includes the capability set identifier. For example, the base station may transmit an uplink or joint transmission configuration indicator (TCI) state update associated with a reported beam or a capability set ID in a beam report. Additionally, or alternatively, the base station may transmit an SRS configuration update (e.g., an SRS TCI state update via a medium access control (MAC) control element (CE) (MAC-CE) or an SRS port configuration update via a radio resource control (RRC) message) associated with a reported beam or a capability set ID in a beam report. Additionally, or alternatively, the base station may transmit a configured grant (CG) PUSCH configuration update (e.g., indicating a TCI state, a port number, or a transmit precoding matrix indicator (TPMI) for a reported beam or a capability set ID in a beam report. Additionally, or alternatively, the base station may transmit a message scheduling an SRS or activating an SRS for a reported beam or a capability set ID in a beam report. Additionally, or alternatively, the base station may transmit a PUSCH dynamic scheduling message for a reported beam or a capability set ID in a beam report.

As a particular example, after receiving the capability value list and the capability set identifier, the base station may schedule an SRS or a PUSCH for codebook transmission on a TCI state in accordance with the capability set associated with the capability set identifier. For example, when the base station receives a capability set identifier indicating two ports that are unused in connection with a particular TCI (where previously a single SRS port had been associated with the particular TCI), the base station may configure SRS resources with the two ports for the particular TCI. Additionally, or alternatively, the base station may trigger SRS transmissions on the particular TCI. Additionally, or alternatively, the base station may transmit DCI to update an uplink TCI to the particular TCI state. Additionally, or alternatively, the base station may transmit a message to reconfigure a CG PUSCH port or a TPMI associated with a PUSCH transmission. Additionally, or alternatively, the base station may transmit DCI to schedule codebook-based PUSCH transmission with a two port TPMJ. However, if the base station misses the report (e.g., as a result of a transmission failure or decoding failure, among other examples), the base station may lose synchronization with the UE. For example, the base station may communicate in a manner in contradiction to the indicated capability set. For example, the base station may schedule a two-port transmission on a one-port TCI. This may result in further communication failures or poor communication performance.

Some aspects described herein enable acknowledgment signaling for panel information reporting. For example, when a UE transmits panel information reporting including a capability value set list and a capability set identifier identifying a capability set of the capability value set list, a base station may transmit a feedback message, such as an acknowledgment (ACK) or negative acknowledgment (NACK) message, as a response to the panel information reporting. In this case, based at least in part on receiving the feedback message, the UE may retransmit the capability set identifier based at least in part on the feedback message indicating that the capability set identifier was not successfully received. After a successful reception of the capability set identifier (in an original transmission or retransmission) and after an application time period elapses, the UE and the base station may use a communication configuration in accordance with the capability set. In this way, the acknowledgment signaling avoids a synchronization loss between a base station and a UE, thereby improving communication performance and reducing a likelihood of dropped communications.

FIG. 4 is a diagram illustrating an example 400 associated with acknowledgment signaling for panel information reporting, in accordance with the present disclosure. As shown in FIG. 4, a base station 110 and a UE 120 may communicate with one another.

As shown by reference numbers 405 and 410, UE 120 may transmit a capability value list and a capability set identifier to base station 110. For example, UE 120 may transmit the capability value list using a first transmission and transmit the capability set identifier using a second transmission. In some aspects, the capability value list may identify one or more capability sets. For example, UE 120 may indicate that a first capability set (Set 0) is associated with 1 port and that a second capability set (Set 1) is associated with 2 ports. In some aspects, UE 120 may transmit the capability set identifier in a downlink beam report. For example, UE 120 may transmit a downlink beam report that includes a capability set identifier (or “capability value set identifier”) corresponding to a port for a reported downlink reference signal. In this case, UE 120 may associate a particular capability set (Set 0) with a particular reference signal (RS) (SSB 5). As described above, the downlink beam report may include a CRI or an SSBI, among other examples, along with the capability set identifier.

As shown by reference number 415, base station 110 may transmit a feedback message. For example, base station 110 may receive the capability set identifier and successfully decode the capability set identifier, and may transmit a feedback message (e.g., an ACK) indicating successful decoding of the capability set identifier. Additionally, or alternatively, base station 110 may fail to receive the capability set identifier during a base station monitoring period or may fail to decode the capability set identifier, and may transmit a feedback message (e.g., a NACK) indicating that receipt or decoding of the capability set identifier was not successful.

In some aspects, base station 110 may transmit, and UE 120 may receive, a NACK when base station 110 is unsuccessful in receiving and/or decoding a CSI report including the capability set identifier. For example, base station 110 may transmit the NACK and may use the NACK to instruct and/or trigger UE 120 to retransmit the CSI report and/or information thereof (e.g., the capability set identifier). In some aspects, base station 110 may reuse DCI signaling for transmitting the NACK. For example, when a first CSI report (e.g., that conveyed the capability set identifier) is an aperiodic CSI report, base station 110 may transmit DCI with the same aperiodic CSI trigger state identifier (e.g., as was used to trigger the first CSI report) to trigger a second CSI report conveying a retransmission of the capability set identifier.

Additionally, or alternatively, when the first CSI report is a semi-persistent or periodic CSI report, base station 110 may transmit DCI with a reserved aperiodic CSI trigger state identifier to trigger a second CSI report conveying a retransmission of the capability set identifier. In this case, the reserved aperiodic CSI trigger state identifier is an identifier value that is reserved for use in triggering retransmissions of the capability set identifier in an aperiodic CSI report. In some aspects, a plurality of reserved aperiodic CSI trigger state identifiers may be configured. For example, base station 110 and UE 120 may be configured with a plurality of reserved aperiodic CSI trigger state identifiers to enable base station 110 to indicate which CSI report, of a plurality of first CSI reports, UE 120 is to retransmit as the second CSI report (e.g., a first identifier corresponds to a most recent CSI report, a second identifier corresponds to a second most recent CSI report, etc.). Additionally, or alternatively, base station 110 may set a field of the DCI to indicate which CSI report, of a plurality of first CSI reports, UE 120 is to retransmit, such as using a HARQ process identifier field to indicate a corresponding report configuration identifier field of the selected CSI report. In some aspects, UE 120 may determine a timing offset between the DCI and the second CSI report based at least in part on a time division resource allocation (TDRA) field in the DCI.

In some aspects, base station 110 may use a reserved sequence to trigger retransmission of a CSI report including a capability set identifier. For example, base station 110 may use a semi-persistent (SP) CSI radio network temporary identifier (RNTI) (SP-CSI-RNTI) in a particular DCI format (e.g., DCI format 0_1) to indicate that UE 120 is to retransmit a CSI report including a capability set identifier (e.g., when a CSI request field and an uplink shared channel (UL-SCH) field are set to ‘0’ as a reserved value for indicating retransmission of a CSI report with a capability set identifier). In this case, base station 110 may use a reserved field or a reserved set of bits to indicate which CSI report is to be retransmitted by UE 120. For example, base station 110 may set a HARQ identifier field to correspond to a report configuration identifier field of a CSI report that is to be retransmitted. In some aspects, UE 120 may determine a timing offset between the DCI and the second CSI report based at least in part on a TDRA field in the DCI and a frequency allocation for the second CSI report based at least in part on a frequency domain resource allocation (FDRA) field in the DCI.

In some aspects, base station 110 may change a sequence between CSI-RSs to indicate a NACK for a CSI report conveying a capability set identifier. For example, base station 110 may use a first sequence for a first CSI-RS and may, for a second CSI-RS after base station 110 has not successfully decoded a CSI report for the first CSI-RS, use a second sequence for the second CSI-RS. In this case, the second sequence may be a reserved or predefined sequence to indicate a NACK to the first CSI-RS. In some aspects, base station 110 and UE 120 may be configured with a plurality of reserved sequences for conveying a NACK, and base station 110 may switch between reserved sequences to indicate different CSI reports (associated with different CSI-RSs) that base station 110 is negatively acknowledging. In this case, using different sequences may avoid additional signaling overhead and may enable UE 120 to detect the NACK by detecting a spatial sequence in a single reserved or predefined location, thereby aiding in decoding of the NACK.

In some aspects, base station 110 may transmit, and UE 120 may receive, an ACK when base station 110 is successful in receiving and/or decoding a CSI report including the capability set identifier. Similar to NACK signaling, as described herein, different signaling paths may be used for the ACK signaling. For example, base station 110 may use dedicated ACK signaling or convey ACK signaling using another type of signaling, such as an SRS or PUSCH TCI state update, an SRS or PUSCH scheduling message, or a reference signal sequence, among other examples.

In some aspects, base station 110 may transmit DCI scheduling a PUSCH to indicate the ACK. For example, when UE 120 is configured to transmit UCI in a PUSCH, base station 110 may transmit DCI scheduling a second PUSCH with a same HARQ identifier as UE 120 used in a first PUSCH to convey an ACK for the first PUSCH. Additionally, or alternatively, base station 110 may include a reserved sequence (e.g., a set of reserved bits or a reserved field) in DCI to indicate an ACK, as described above with regard to indicating a NACK. For example, base station 110 may include a reserved sequence and an RNTI in the DCI to indicate an ACK to UE 120 (e.g., DCI format 0_0 or 0_1 with a configured scheduling (CS) RNTI (CS-RNTI), with a new data indicator (NDI) field set to a reserved value of ‘0’, or with a reserved validation sequence in a redundancy version (RV) field or in an FDRA field, among other examples).

Additionally, or alternatively, base station 110 may use different CSI-RS sequences to indicate an ACK. For example, as described with regard to NACK signaling, base station 110 may transmit a CSI-RS with a reserved or predefined sequence to indicate an ACK for a CSI report associated with a previous CSI-RS. In some aspects, base station 110 may reuse another signaling message to indicate an ACK (or a NACK, in some cases). For example, when base station 110 is to switch from a current TCI state to a new TCI state, base station 110 may transmit a DCI (e.g., to update a TCI state of a PUSCH or PUCCH or to schedule an SRS or PUSCH via a TCI state) or a MAC-CE (e.g., to update or activate a TCI state associated with the CSI report). Additionally, or alternatively, base station 110 may transmit signaling to update a TCI state pool, to change a persistent or semi-persistent SRS resource, or to change a configured grant (CG) PUSCH configuration, among other examples. In these cases, UE 120 may be configured to interpret the received signaling during a monitoring window as an ACK for the transmitted CSI report that includes the capability set identifier for which the change is applicable. For example, the monitoring window may start from a first time period time after UE sends the CSI report and last for a second time period. The first time period may correspond to a decoding time of the CSI report at base station 110. The first time period and the second period time may be configured by base station 110 or predefined statically for UE 120 in a standard specification. Additionally, or alternatively, when a TCI state associated with a reported downlink reference signal is currently in use, base station 110 may transmit signaling that UE 120 may interpret as an ACK. For example, base station 110 may transmit signaling to update an SRS or CG PUSCH port configuration, DCI to indicate a new PUSCH or SRS with a corresponding port number (e.g., where a reported port is larger than the previous one), or a dedicated DCI to update a TCI (e.g., to a TCI that is already in use) without a DL-SCH assignment

In some aspects, base station 110 may be configured to transmit both ACK signaling and NACK signaling. For example, base station 110 and UE 120 may be configured with a first monitoring window for transmitting and receiving, respectively, the NACK signaling and a second monitoring window for transmitting and receiving, respectively, the ACK signaling. In this case, when UE 120 does not receive a NACK message in the first monitoring window (which is shorter than the second monitoring window), UE 120 may monitor for the ACK message in the second monitoring window. In this way, having both ACK signaling and NACK signaling provides for reduced latency and improved robustness for UE 120 and base station 110. Alternatively, base station 110 may be configured only for NACK signaling. In this case, UE 120 may monitor for the NACK signaling in a monitoring window and may, if no NACK signaling is received in the monitoring window, determine that base station 110 was successful in decoding a CSI report including the capability set identifier. In this way, having only NACK signaling (or similarly, only ACK signaling) configured for base station 110 may reduce an amount of signaling, thereby reducing network congestion.

As shown by reference number 420, in some aspects, UE 120 may retransmit information identifying the capability set identifier. For example, based at least in part on receiving an indication that the capability set identifier was not successfully decoded (e.g., a NACK), UE 120 may retransmit information identifying the capability set identifier to enable successful decoding of the capability set identifier. In this case, UE 120 may subsequently monitor for an ACK to the retransmission of the information identifying the capability set identifier (e.g., the retransmission of the CSI report to which the NACK applied).

As shown by reference number 425, base station 110 may schedule transmission in accordance with the capability set. For example, base station 110 and UE 120 may, after an application time period has elapsed, apply the capability set to scheduling an SRS and/or a PUSCH for codebook transmission on a TCI state associated with the capability set. In this case, base station 110 may not schedule an SRS and/or a PUSCH with a reported port associated with the capability set using a downlink beam until after the application time period is elapsed.

In some aspects, UE 120 and base station 110 may derive the application time period, which is a time period after which to apply the capability set and/or a communication configuration related thereto, based at least in part on a transmission of an ACK. For example, when base station 110 transmits an ACK (e.g., to an initial CSI report including a capability set identifier or to a retransmission of the CSI report), base station 110 and UE 120 may apply the capability set associated with the capability set identifier after a time period starting from transmission of (or reception of) the ACK. Additionally, or alternatively, base station 110 and UE 120 may determine the application time based at least in part on a transmission of (or reception of) the CSI report that includes the capability set identifier. In some aspects, base station 110 and UE 120 may determine the application time based at least in part on whether a panel activation is occurring. For example, when UE 120 is to activate a new panel for a communication configuration associated with the capability set, UE 120 may indicate the panel activation in the CSI report that includes the capability set identifier for the capability set. In this case, base station 110 may determine a length of the application time period based at least in part on whether the panel activation is indicated to occur (e.g., base station 110 may allow a longer application time period when a panel activation is to occur to allow for a delay in updating a communication configuration associated with activating a panel). In some aspects, such as for CG PUSCH, SP SRS or periodic SRS, UE 120 and base station 110 may update panel information. For example, UE 120 may update the panel information in a communication configuration after an application time period has elapsed or based at least in part on receiving reactivation signaling from base station 110 (e.g., when a reported number of ports in the capability set is fewer than was previously configured).

As indicated above, FIG. 4 is provided as an example. Other examples may differ from what is described with respect to FIG. 4.

FIG. 5 is a diagram illustrating an example process 500 performed, for example, by a UE, in accordance with the present disclosure. Example process 500 is an example where the UE (e.g., UE 120) performs operations associated with acknowledgment signaling for panel information reports.

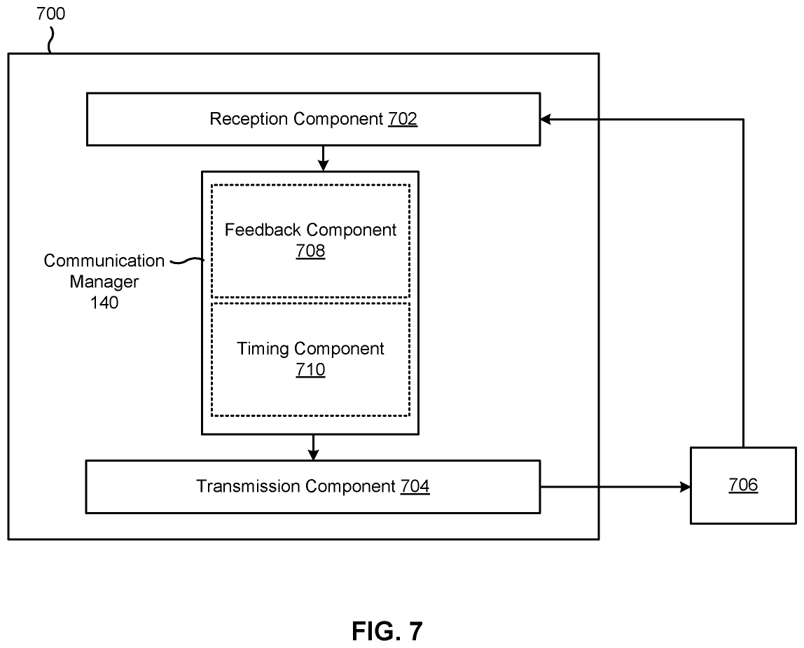

As shown in FIG. 5, in some aspects, process 500 may include transmitting, to a base station, a capability value set list identifying one or more capability sets (block 510). For example, the UE (e.g., using communication manager 140 and/or transmission component 704, depicted in FIG. 7) may transmit, to a base station, a capability value set list identifying one or more capability sets, as described above.

As further shown in FIG. 5, in some aspects, process 500 may include transmitting, to the base station, a CSI report that includes a capability set identifier identifying a capability set of the one or more capability sets of the capability value set list (block 520). For example, the UE (e.g., using communication manager 140 and/or transmission component 704, depicted in FIG. 7) may transmit, to the base station, a CSI report that includes a capability set identifier identifying a capability set of the one or more capability sets of the capability value set list, as described above.

As further shown in FIG. 5, in some aspects, process 500 may include receiving a feedback message indicating whether the base station successfully received the CSI report and whether to retransmit information identifying the capability set identifier (block 530). For example, the UE (e.g., using communication manager 140 and/or reception component 702, depicted in FIG. 7) may receive a feedback message indicating whether the base station successfully received the CSI report and whether to retransmit information identifying the capability set identifier, as described above.

Process 500 may include additional aspects, such as any single aspect or any combination of aspects described below and/or in connection with one or more other processes described elsewhere herein.

In a first aspect, the capability set identifier is associated with a parameter identifying at least a maximum quantity of supported uplink transmission layers, a maximum quantity of supported sounding reference signal ports, a set of supported coherence types corresponding to a subset of ports, or some combination thereof.

In a second aspect, alone or in combination with the first aspect, the feedback message is a negative acknowledgment message indicating a failure to receive or decode the CSI report and requesting a retransmission of the CSI report.

In a third aspect, alone or in combination with one or more of the first and second aspects, the feedback message is an acknowledgment message confirming successful reception of the CSI report.

In a fourth aspect, alone or in combination with one or more of the first through third aspects, the acknowledgment message is conveyed via at least a hybrid automatic repeat request identifier, a dedicated acknowledgment message, a transmission configuration indicator update message, a sounding reference signal update message, downlinking control information scheduling a sounding reference signal or a physical uplink shared channel message, an activation message for a sounding reference signal or a configured grant physical uplink shared channel message, a transmission configuration indicator state update message associated with the CSI report, a scheduling message, a reference signal sequence, or some combination thereof.

In a fifth aspect, alone or in combination with one or more of the first through fourth aspects, the feedback message is the dedicated acknowledgment message conveyed in downlink control information with at least a reserved sequence for the feedback message, a set of reserved bits for the feedback message, a reserved field for the feedback message, a format configured for the feedback message, a scrambled radio network temporary identifier for the feedback message, or some combination thereof.

In a sixth aspect, alone or in combination with one or more of the first through fifth aspects, the UE is configured to monitor for the feedback message during a configured time window.

In a seventh aspect, alone or in combination with one or more of the first through sixth aspects, the configured time window includes a first interval for monitoring for a negative acknowledgment and a second time interval for monitoring for an acknowledgment.

In an eighth aspect, alone or in combination with one or more of the first through seventh aspects, the CSI report is an aperiodic CSI report and the feedback message is included in downlink control information that shares an aperiodic CSI trigger state identifier with the CSI report.

In a ninth aspect, alone or in combination with one or more of the first through eighth aspects, the CSI report is a semi-persistent scheduled CSI report or a periodic scheduled CSI report, and the feedback message is conveyed in downlink control information and triggers an aperiodic CSI report to convey information of the CSI report.

In a tenth aspect, alone or in combination with one or more of the first through ninth aspects, the downlink control information is associated with an aperiodic trigger state or a validation sequence, and the aperiodic trigger state or the validation sequence triggers the aperiodic CSI report to convey the information of the CSI report.

In an eleventh aspect, alone or in combination with one or more of the first through tenth aspects, the downlink control information includes an identifier of the CSI report for which the aperiodic CSI report is to convey information of the CSI report.

In a twelfth aspect, alone or in combination with one or more of the first through eleventh aspects, whether the feedback message indicates successful receipt of the CSI report is based at least in part on detecting a sequence of a CSI reference signal associated with the CSI report.

In a thirteenth aspect, alone or in combination with one or more of the first through twelfth aspects, the feedback message is a dedicated acknowledgment message, and the CSI report is conveyed in uplink control information of a first physical uplink shared channel (PUSCH) with a hybrid automatic repeat request (HARQ) identifier and the feedback message is conveyed in downlink control information scheduling a second PUSCH corresponding to a new data transport block with the HARQ identifier.

In a fourteenth aspect, alone or in combination with one or more of the first through thirteenth aspects, the UE is configured to identify that the feedback message is an acknowledgment message conveyed in downlink control information based at least in part on a change to a CSI-RS sequence associated with the CSI report.

In a fifteenth aspect, alone or in combination with one or more of the first through fourteenth aspects, an application time for using the capability set is based at least in part on a time of the CSI report or the feedback message.

In a sixteenth aspect, alone or in combination with one or more of the first through fifteenth aspects, the feedback message indicates whether a panel activation is to occur, and an application time for using the capability set is based at least in part on whether the panel activation is to occur.

In a seventeenth aspect, alone or in combination with one or more of the first through sixteenth aspects, the UE is configured to receive a transmission from the base station in accordance with the capability set based at least in part on a type of the transmission and an application time for using the capability set elapsing.

In an eighteenth aspect, alone or in combination with one or more of the first through seventeenth aspects, the UE is configured to receive a transmission from the base station in accordance with the capability set based at least in part on a type of the transmission and reactivation signaling from the base station.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by a base station, in accordance with the present disclosure. Example process 600 is an example where the base station (e.g., base station 110) performs operations associated with acknowledgment signaling for panel information reports.

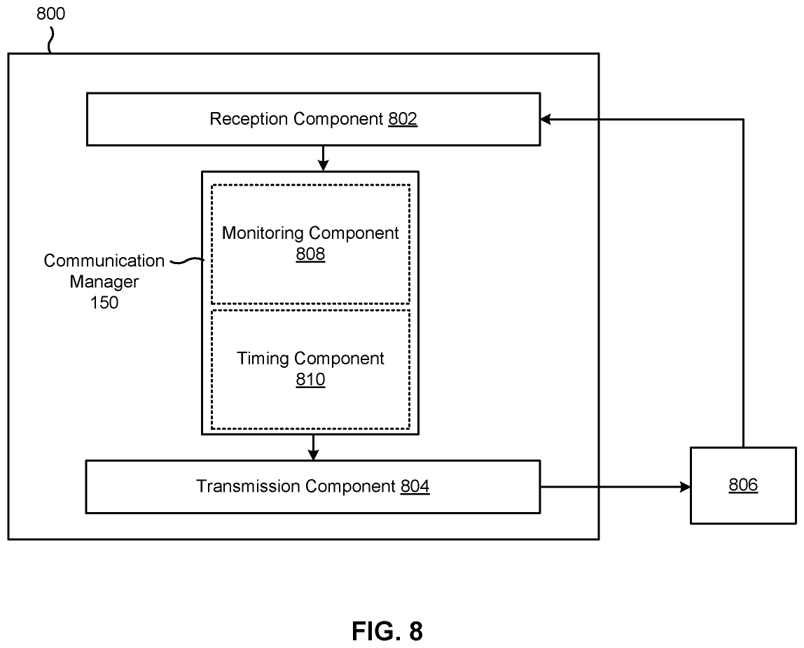

As shown in FIG. 6, in some aspects, process 600 may include receiving, from a UE, a capability value set list identifying one or more capability sets (block 610). For example, the base station (e.g., using communication manager 150 and/or reception component 802, depicted in FIG. 8) may receive, from a UE, a capability value set list identifying one or more capability sets, as described above.

As further shown in FIG. 6, in some aspects, process 600 may include monitoring for a CSI report, from the UE, that includes a capability set identifier identifying a capability set of the one or more capability sets of the capability value set list (block 620). For example, the base station (e.g., using communication manager 150 and/or monitoring component 808, depicted in FIG. 8) may monitor for a CSI report, from the UE, that includes a capability set identifier identifying a capability set of the one or more capability sets of the capability value set list, as described above.

As further shown in FIG. 6, in some aspects, process 600 may include transmitting a feedback message indicating whether the CSI report is successfully received and whether to retransmit information identifying the capability set identifier (block 630). For example, the base station (e.g., using communication manager 150 and/or transmission component 804, depicted in FIG. 8) may transmit a feedback message indicating whether the CSI report is successfully received and whether to retransmit information identifying the capability set identifier, as described above.

Process 600 may include additional aspects, such as any single aspect or any combination of aspects described below and/or in connection with one or more other processes described elsewhere herein.

In a first aspect, the capability set identifier is associated with a parameter identifying at least a maximum quantity of supported uplink transmission layers, a maximum quantity of supported sounding reference signal ports, a set of supported coherence types corresponding to a subset of ports, or some combination thereof.

In a second aspect, alone or in combination with the first aspect, the feedback message is a negative acknowledgment message indicating a failure to receive or decode the CSI report and requesting a retransmission of the CSI report.

In a third aspect, alone or in combination with one or more of the first and second aspects, the feedback message is an acknowledgment message confirming successful reception of the CSI report.

In a fourth aspect, alone or in combination with one or more of the first through third aspects, the acknowledgment message is conveyed via at least a hybrid automatic repeat request identifier, a dedicated acknowledgment message, a transmission configuration indicator update message, a sounding reference signal update message, downlinking control information scheduling a sounding reference signal or a physical uplink shared channel message, an activation message for a sounding reference signal or a configured grant physical uplink shared channel message, a transmission configuration indicator state update message associated with the CSI report, a scheduling message, a reference signal sequence, or some combination thereof.

In a fifth aspect, alone or in combination with one or more of the first through fourth aspects, the feedback message is the dedicated acknowledgment message conveyed in downlink control information with at least a reserved sequence for the feedback message, a set of reserved bits for the feedback message, a reserved field for the feedback message, a format configured for the feedback message, a scrambled radio network temporary identifier for the feedback message, or some combination thereof.

In a sixth aspect, alone or in combination with one or more of the first through fifth aspects, the base station is configured to transmit for the feedback message during a configured time window in which the UE is configured to monitor for the feedback message.

In a seventh aspect, alone or in combination with one or more of the first through sixth aspects, the configured time window includes a first interval for transmission of a negative acknowledgment and a second time interval for transmission of an acknowledgment.

In an eighth aspect, alone or in combination with one or more of the first through seventh aspects, the CSI report is an aperiodic CSI report and the feedback message is included in downlink control information that shares an aperiodic CSI trigger state identifier with the CSI report.

In a ninth aspect, alone or in combination with one or more of the first through eighth aspects, the CSI report is a semi-persistent scheduled CSI report or a periodic scheduled CSI report, and the feedback message is conveyed in downlink control information and triggers an aperiodic CSI report to convey information of the CSI report.

In a tenth aspect, alone or in combination with one or more of the first through ninth aspects, the downlink control information is associated with an aperiodic trigger state or a validation sequence, and the aperiodic trigger state or the validation sequence triggers the aperiodic CSI report to convey the information of the CSI report.

In an eleventh aspect, alone or in combination with one or more of the first through tenth aspects, the downlink control information includes an identifier of the CSI report for which the aperiodic CSI report is to convey information of the CSI report.

In a twelfth aspect, alone or in combination with one or more of the first through eleventh aspects, whether the feedback message indicates successful receipt of the CSI report is based at least in part on detecting a sequence of a CSI reference signal associated with the CSI report.

In a thirteenth aspect, alone or in combination with one or more of the first through twelfth aspects, the feedback message is a dedicated acknowledgment message, and the CSI report is conveyed in uplink control information of a first PUSCH with a HARQ identifier and the feedback message is conveyed in downlink control information scheduling a second PUSCH corresponding to a new data transport block with the HARQ identifier.

In a fourteenth aspect, alone or in combination with one or more of the first through thirteenth aspects, the base station is configured to change a CSI reference signal sequence in the downlink control information to indicate to the UE that the feedback message is an acknowledgment message conveyed in downlink control information.

In a fifteenth aspect, alone or in combination with one or more of the first through fourteenth aspects, an application time for using the capability set is based at least in part on a time of the CSI report or the feedback message.

In a sixteenth aspect, alone or in combination with one or more of the first through fifteenth aspects, the feedback message indicates whether a panel activation is to occur, and an application time for using the capability set is based at least in part on whether the panel activation is to occur.

In a seventeenth aspect, alone or in combination with one or more of the first through sixteenth aspects, the base station is configured to transmit in accordance with the capability set based at least in part on a type of the transmission and an application time for using the capability set elapsing.

In an eighteenth aspect, alone or in combination with one or more of the first through seventeenth aspects, the base station is configured to transmit in accordance with the capability set based at least in part on a type of the transmission and reactivation signaling from the base station.

In a nineteenth aspect, alone or in combination with one or more of the first through eighteenth aspects, process 600 includes scheduling a transmission in accordance with the reported capability value set based at least in part on successfully receiving the CSI report

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include the communication manager 140. The communication manager 140 may include one or more of a feedback component 708 or a timing component 710, among other examples.

In some aspects, the apparatus 700 may be configured to perform one or more operations described herein in connection with FIG. 4. Additionally, or alternatively, the apparatus 700 may be configured to perform one or more processes described herein, such as process 500 of FIG. 5. In some aspects, the apparatus 700 and/or one or more components shown in FIG. 7 may include one or more components of the UE described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the UE described in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the UE described in connection with FIG. 2. In some aspects, the transmission component 704 may be co-located with the reception component 702 in a transceiver.

The transmission component 704 may transmit, to a base station, a capability value set list identifying one or more capability sets. The transmission component 704 may transmit, to the base station, a CSI report that includes a capability set identifier identifying a capability set of the one or more capability sets of the capability value set list. The reception component 702 may receive a feedback message indicating whether the base station successfully received the CSI report and whether to retransmit information identifying the capability set identifier. The feedback component 708 may determine whether a received feedback message indicates that the capability set identifier has been successfully received and whether to retransmit information identifying the capability set identifier. The transmission component 704 may retransmit the information identifying the capability set identifier. The timing component 710 may determine a timing to implement a communication configuration associated with the capability set.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication. The apparatus 800 may be a base station, or a base station may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 150. The communication manager 150 may include one or more of a monitoring component 808 or a timing component 810, among other examples.

In some aspects, the apparatus 800 may be configured to perform one or more operations described herein in connection with FIG. 4. Additionally, or alternatively, the apparatus 800 may be configured to perform one or more processes described herein, such as process 600 of FIG. 6. In some aspects, the apparatus 800 and/or one or more components shown in FIG. 8 may include one or more components of the base station described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the base station described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the base station described in connection with FIG. 2. In some aspects, the transmission component 804 may be co-located with the reception component 802 in a transceiver.

The reception component 802 may receive, from a UE, a capability value set list identifying one or more capability sets. The monitoring component 808 may monitor for a CSI report, from the UE, that includes a capability set identifier identifying a capability set of the one or more capability sets of the capability value set list. The transmission component 804 may transmit a feedback message indicating whether the CSI report is successfully received and whether to retransmit information identifying the capability set identifier. The timing component 810 may determine a timing for implementing a communication configuration associated with the capability set.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: transmitting, to a base station, a capability value set list identifying one or more capability sets; transmitting, to the base station, a channel state information (CSI) report that includes a capability set identifier identifying a capability set of the one or more capability sets of the capability value set list; and receiving a feedback message indicating whether the base station successfully received the CSI report and whether to retransmit information identifying the capability set identifier.

Aspect 2: The method of Aspect 1, wherein the capability set identifier is associated with a parameter identifying at least: a maximum quantity of supported uplink transmission layers, a maximum quantity of supported sounding reference signal ports, a set of supported coherence types corresponding to a subset of ports, or some combination thereof.

Aspect 3: The method of any of Aspects 1 to 2, wherein the feedback message is a negative acknowledgment message indicating a failure to receive or decode the CSI report and requesting a retransmission of the CSI report.

Aspect 4: The method of any of Aspects 1 to 3, wherein the feedback message is an acknowledgment message confirming successful reception of the CSI report.

Aspect 5: The method of Aspect 4, wherein the acknowledgment message is conveyed via at least: a hybrid automatic repeat request identifier, a dedicated acknowledgment message, a transmission configuration indicator update message, a sounding reference signal update message, downlink control information scheduling a sounding reference signal or a physical uplink shared channel message, an activation message for a sounding reference signal or a configured grant physical uplink shared channel message, a transmission configuration indicator state update message associated with the CSI report, a scheduling message, a reference signal sequence, or some combination thereof.

Aspect 6: The method of Aspect 5, wherein the feedback message is the dedicated acknowledgment message conveyed in downlink control information with at least: a reserved sequence for the feedback message, a set of reserved bits for the feedback message, a reserved field for the feedback message, a format configured for the feedback message, a scrambled radio network temporary identifier for the feedback message, or some combination thereof.

Aspect 7: The method of any of Aspects 1 to 6, wherein the UE is configured to monitor for the feedback message during a configured time window.

Aspect 8: The method of Aspect 7, wherein the configured time window includes a first interval for monitoring for a negative acknowledgment and a second time interval for monitoring for an acknowledgment.

Aspect 9: The method of any of Aspects 1 to 8, wherein the CSI report is an aperiodic CSI report and the feedback message is included in downlink control information that shares an aperiodic CSI trigger state identifier with the CSI report.

Aspect 10: The method of any of Aspects 1 to 9, wherein the CSI report is a semi-persistent scheduled CSI report or a periodic scheduled CSI report, and wherein the feedback message is conveyed in downlink control information and triggers an aperiodic CSI report to convey information of the CSI report.

Aspect 11: The method of Aspect 10, wherein the downlink control information is associated with an aperiodic trigger state or a validation sequence, and wherein the aperiodic trigger state or the validation sequence triggers the aperiodic CSI report to convey the information of the CSI report.

Aspect 12: The method of Aspect 10, where the downlink control information includes an identifier of the CSI report for which the aperiodic CSI report is to convey information of the CSI report.

Aspect 13: The method of any of Aspects 1 to 12, wherein whether the feedback message indicates successful receipt of the CSI report is based at least in part on detecting a sequence of a CSI reference signal associated with the CSI report.

Aspect 14: The method of any of Aspects 1 to 13, wherein the feedback message is a dedicated acknowledgment message, and wherein the CSI report is conveyed in uplink control information of a first physical uplink shared channel (PUSCH) with a hybrid automatic repeat request (HARQ) identifier and the feedback message is conveyed in downlink control information scheduling a second PUSCH corresponding to a new data transport block with the HARQ identifier.

Aspect 15: The method of any of Aspects 1 to 14, wherein the UE is configured to identify that the feedback message is an acknowledgment message conveyed in downlink control information based at least in part on a change to a CSI-RS sequence associated with the CSI report.

Aspect 16: The method of any of Aspects 1 to 15, wherein an application time for using the capability set is based at least in part on a time of the CSI report or the feedback message.

Aspect 17: The method of any of Aspects 1 to 16, wherein the feedback message indicates whether a panel activation is to occur, and wherein an application time for using the capability set is based at least in part on whether the panel activation is to occur.

Aspect 18: The method of any of Aspects 1 to 17, wherein the UE is configured to receive a transmission from the base station in accordance with the capability set based at least in part on a type of the transmission and an application time for using the capability set elapsing.

Aspect 19: The method of any of Aspects 1 to 17, wherein the UE is configured to receive a transmission from the base station in accordance with the capability set based at least in part on a type of the transmission and reactivation signaling from the base station.

Aspect 20: A method of wireless communication performed by a base station, comprising: receiving, from a user equipment (UE), a capability value set list identifying one or more capability sets; monitoring for a channel state information (CSI) report, from the UE, that includes a capability set identifier identifying a capability set of the one or more capability sets of the capability value set list; and transmitting a feedback message indicating whether the CSI report is successfully received and whether to retransmit information identifying the capability set identifier.

Aspect 21: The method of Aspect 20, wherein the capability set identifier is associated with a parameter identifying at least: a maximum quantity of supported uplink transmission layers, a maximum quantity of supported sounding reference signal ports, a set of supported coherence types corresponding to a subset of ports, or some combination thereof.

Aspect 22: The method of any of Aspects 20 to 21, wherein the feedback message is a negative acknowledgment message indicating a failure to receive or decode the CSI report and requesting a retransmission of the CSI report.

Aspect 23 The method of any of Aspects 20 to 22, wherein the feedback message is an acknowledgment message confirming successful reception of the CSI report.

Aspect 24: The method of Aspect 23, wherein the acknowledgment message is conveyed via at least: a hybrid automatic repeat request identifier, a dedicated acknowledgment message, a transmission configuration indicator update message, a sounding reference signal update message, downlink control information scheduling a sounding reference signal or a physical uplink shared channel message, an activation message for a sounding reference signal or a configured grant physical uplink shared channel message, a transmission configuration indicator state update message associated with the CSI report, a scheduling message, a reference signal sequence, or some combination thereof.

Aspect 25: The method of Aspect 24, wherein the feedback message is the dedicated acknowledgment message conveyed in downlink control information with at least: a reserved sequence for the feedback message, a set of reserved bits for the feedback message, a reserved field for the feedback message, a format configured for the feedback message, a scrambled radio network temporary identifier for the feedback message, or some combination thereof.

Aspect 26: The method of any of Aspects 20 to 25, wherein the base station is configured to transmit for the feedback message during a configured time window in which the UE is configured to monitor for the feedback message.

Aspect 27: The method of Aspect 26, wherein the configured time window includes a first interval for transmission of a negative acknowledgment and a second time interval for transmission of an acknowledgment.

Aspect 28: The method of any of Aspects 20 to 27, wherein the CSI report is an aperiodic CSI report and the feedback message is included in downlink control information that shares an aperiodic CSI trigger state identifier with the CSI report.

Aspect 29: The method of any of Aspects 20 to 28, wherein the CSI report is a semi-persistent scheduled CSI report or a periodic scheduled CSI report, and wherein the feedback message is conveyed in downlink control information and triggers an aperiodic CSI report to convey information of the CSI report.

Aspect 30: The method of Aspect 29, wherein the downlink control information is associated with an aperiodic trigger state or a validation sequence, and wherein the aperiodic trigger state or the validation sequence triggers the aperiodic CSI report to convey the information of the CSI report.

Aspect 31: The method of Aspect 29, where the downlink control information includes an identifier of the CSI report for which the aperiodic CSI report is to convey information of the CSI report.

Aspect 32: The method of any of Aspects 20 to 31, wherein whether the feedback message indicates successful receipt of the CSI report is based at least in part on detecting a sequence of a CSI reference signal associated with the CSI report.

Aspect 33: The method of any of Aspects 20 to 32, wherein the feedback message is a dedicated acknowledgment message, and wherein the CSI report is conveyed in uplink control information of a first physical uplink shared channel (PUSCH) with a hybrid automatic repeat request (HARQ) identifier and the feedback message is conveyed in downlink control information scheduling a second PUSCH corresponding to a new data transport block with the HARQ identifier.

Aspect 34: The method of any of Aspects 20 to 33, wherein the base station is configured to change a CSI reference signal sequence in the downlink control information to indicate to the UE that the feedback message is an acknowledgment message conveyed in downlink control information.

Aspect 35: The method of any of Aspects 20 to 34, wherein an application time for using the capability set is based at least in part on a time of the CSI report or the feedback message.

Aspect 36: The method of any of Aspects 20 to 35, wherein the feedback message indicates whether a panel activation is to occur, and wherein an application time for using the capability set is based at least in part on whether the panel activation is to occur.

Aspect 37: The method of any of Aspects 20 to 36, wherein the base station is configured to transmit in accordance with the capability set based at least in part on a type of the transmission and an application time for using the capability set elapsing.

Aspect 38: The method of any of Aspects 20 to 37, wherein the base station is configured to transmit in accordance with the capability set based at least in part on a type of the transmission and reactivation signaling from the base station.

Aspect 39: An apparatus for wireless communication at a device, comprising a processor; memory coupled with the processor; and instructions stored in the memory and executable by the processor to cause the apparatus to perform the method of one or more of Aspects 1-19.

Aspect 40: A device for wireless communication, comprising a memory and one or more processors coupled to the memory, the one or more processors configured to perform the method of one or more of Aspects 1-19.

Aspect 41: An apparatus for wireless communication, comprising at least one means for performing the method of one or more of Aspects 1-19.

Aspect 42: A non-transitory computer-readable medium storing code for wireless communication, the code comprising instructions executable by a processor to perform the method of one or more of Aspects 1-19.

Aspect 43: A non-transitory computer-readable medium storing a set of instructions for wireless communication, the set of instructions comprising one or more instructions that, when executed by one or more processors of a device, cause the device to perform the method of one or more of Aspects 1-19.

Aspect 39: An apparatus for wireless communication at a device, comprising a processor; memory coupled with the processor; and instructions stored in the memory and executable by the processor to cause the apparatus to perform the method of one or more of Aspects 20-38.

Aspect 40: A device for wireless communication, comprising a memory and one or more processors coupled to the memory, the one or more processors configured to perform the method of one or more of Aspects 20-38.

Aspect 41: An apparatus for wireless communication, comprising at least one means for performing the method of one or more of Aspects 20-38.

Aspect 42: A non-transitory computer-readable medium storing code for wireless communication, the code comprising instructions executable by a processor to perform the method of one or more of Aspects 20-38.

Aspect 43: A non-transitory computer-readable medium storing a set of instructions for wireless communication, the set of instructions comprising one or more instructions that, when executed by one or more processors of a device, cause the device to perform the method of one or more of Aspects 20-38.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
transmit, to a base station, a capability value set list identifying one or more capability sets;
transmit, to the base station, a channel state information (CSI) report that includes a capability set identifier identifying a capability set of the one or more capability sets of the capability value set list; and
receive a feedback message indicating whether the base station successfully received the CSI report and whether to retransmit information identifying the capability set identifier.

2. The UE of claim 1, wherein the capability set identifier is associated with a parameter identifying at least:
a maximum quantity of supported uplink transmission layers,
a maximum quantity of supported sounding reference signal ports,
a set of supported coherence types corresponding to a subset of ports, or some combination thereof.

3. The UE of claim 1, wherein the feedback message is a negative acknowledgment message indicating a failure to receive or decode the CSI report and requesting a retransmission of the CSI report.

4. The UE of claim 1, wherein the feedback message is an acknowledgment message confirming successful reception of the CSI report.

5. The UE of claim 4, wherein the acknowledgment message is conveyed via at least:
a hybrid automatic repeat request identifier,
a dedicated acknowledgment message,
a transmission configuration indicator update message,
a sounding reference signal update message,
downlink control information scheduling a sounding reference signal or a physical uplink shared channel message,
an activation message for a sounding reference signal or a configured grant physical uplink shared channel message,
a transmission configuration indicator state update message associated with the CSI report,
a scheduling message,
a reference signal sequence, or
some combination thereof.

6. The UE of claim 5, wherein the feedback message is the dedicated acknowledgment message conveyed in downlink control information with at least:
a reserved sequence for the feedback message,
a set of reserved bits for the feedback message,
a reserved field for the feedback message,
a format configured for the feedback message,
a scrambled radio network temporary identifier for the feedback message, or some combination thereof.

7. The UE of claim 1, wherein the UE is configured to monitor for the feedback message during a configured time window.

8. The UE of claim 7, wherein the configured time window includes a first interval for monitoring for a negative acknowledgment and a second time interval for monitoring for an acknowledgment.

9. The UE of claim 1, wherein the CSI report is an aperiodic CSI report and the feedback message is included in downlink control information that shares an aperiodic CSI trigger state identifier with the CSI report.

10. The UE of claim 1, wherein the CSI report is a semi-persistent scheduled CSI report or a periodic scheduled CSI report, and
wherein the feedback message is conveyed in downlink control information and triggers an aperiodic CSI report to convey information of the CSI report.

11. The UE of claim 10, wherein the downlink control information is associated with an aperiodic trigger state or a validation sequence, and
wherein the aperiodic trigger state or the validation sequence triggers the aperiodic CSI report to convey the information of the CSI report.

12. The UE of claim 10, where the downlink control information includes an identifier of the CSI report for which the aperiodic CSI report is to convey information of the CSI report.

13. The UE of claim 1, wherein whether the feedback message indicates successful receipt of the CSI report is based at least in part on detecting a sequence of a CSI reference signal associated with the CSI report.

14. The UE of claim 1, wherein the feedback message is a dedicated acknowledgment message, and
wherein the CSI report is conveyed in uplink control information of a first physical uplink shared channel (PUSCH) with a hybrid automatic repeat request (HARQ) identifier and the feedback message is conveyed in downlink control information scheduling a second PUSCH corresponding to a new data transport block with the HARQ identifier.

15. The UE of claim 1, wherein the UE is configured to identify that the feedback message is an acknowledgment message conveyed in downlink control information based at least in part on a change to a CSI-RS sequence associated with the CSI report.

16. The UE of claim 1, wherein an application time for using the capability set is based at least in part on a time of the CSI report or the feedback message.

17. The UE of claim 1, wherein the feedback message indicates whether a panel activation is to occur, and wherein an application time for using the capability set is based at least in part on whether the panel activation is to occur.

18. The UE of claim 1, wherein the UE is configured to receive a transmission from the base station in accordance with the capability set based at least in part on a type of the transmission and an application time for using the capability set elapsing.

19. The UE of claim 1, wherein the UE is configured to receive a transmission from the base station in accordance with the capability set based at least in part on a type of the transmission and reactivation signaling from the base station.

20. A base station for wireless communication, comprising:
a memory; and
one or more processors, coupled to the memory, configured to:
receive, from a user equipment (UE), a capability value set list identifying one or more capability sets;
monitor for a channel state information (CSI) report, from the UE, that includes a capability set identifier identifying a capability set of the one or more capability sets of the capability value set list; and
transmit a feedback message indicating whether the CSI report is successfully received and whether to retransmit information identifying the capability set identifier.

21. The base station of claim 20, wherein the capability set identifier is associated with a parameter identifying at least:
a maximum quantity of supported uplink transmission layers,
a maximum quantity of supported sounding reference signal ports,
a set of supported coherence types corresponding to a subset of ports, or
some combination thereof.

22. The base station of claim 20, wherein the feedback message is a negative acknowledgment message indicating a failure to receive or decode the CSI report and requesting a retransmission of the CSI report.

23. The base station of claim 20, wherein the feedback message is an acknowledgment message confirming successful reception of the CSI report.

24. The base station of claim 23, wherein the acknowledgment message is conveyed via at least:
a hybrid automatic repeat request identifier,
a dedicated acknowledgment message,
a transmission configuration indicator update message,
a sounding reference signal update message,
downlink control information scheduling a sounding reference signal or a physical uplink shared channel message,
an activation message for a sounding reference signal or a configured grant physical uplink shared channel message,
a transmission configuration indicator state update message associated with the CSI report,
a scheduling message,
a reference signal sequence, or
some combination thereof.

25. The base station of claim 24, wherein the feedback message is the dedicated acknowledgment message conveyed in downlink control information with at least:
a reserved sequence for the feedback message,
a set of reserved bits for the feedback message,
a reserved field for the feedback message,
a format configured for the feedback message,
a scrambled radio network temporary identifier for the feedback message, or
some combination thereof.

26. The base station of claim 20, wherein the base station is configured to transmit for the feedback message during a configured time window in which the UE is configured to monitor for the feedback message.

27. The base station of claim 26, wherein the configured time window includes a first interval for transmission of a negative acknowledgment and a second time interval for transmission of an acknowledgment.

28. The base station of claim 20, wherein the CSI report is an aperiodic CSI report and the feedback message is included in downlink control information that shares an aperiodic CSI trigger state identifier with the CSI report.

29. The base station of claim 20, wherein the CSI report is a semi-persistent scheduled CSI report or a periodic scheduled CSI report, and
wherein the feedback message is conveyed in downlink control information and triggers an aperiodic CSI report to convey information of the CSI report.

30. The base station of claim 29, wherein the downlink control information is associated with an aperiodic trigger state or a validation sequence, and
wherein the aperiodic trigger state or the validation sequence triggers the aperiodic CSI report to convey the information of the CSI report.

31. A method of wireless communication performed by a user equipment (UE), comprising:
transmitting, to a base station, a capability value set list identifying one or more capability sets;
transmitting, to the base station, a channel state information (CSI) report that includes a capability set identifier identifying a capability set of the one or more capability sets of the capability value set list; and
receiving a feedback message indicating whether the base station successfully received the CSI report and whether to retransmit information identifying the capability set identifier.

32. The method of claim 31, wherein the capability set identifier is associated with a parameter identifying at least:
a maximum quantity of supported uplink transmission layers,
a maximum quantity of supported sounding reference signal ports,
a set of supported coherence types corresponding to a subset of ports, or
some combination thereof.

33. The method of claim 31, wherein the feedback message is a negative acknowledgment message indicating a failure to receive or decode the CSI report and requesting a retransmission of the CSI report.

34. A method of wireless communication performed by a base station, comprising:
receiving, from a user equipment (UE), a capability value set list identifying one or more capability sets;
monitoring for a channel state information (CSI) report, from the UE, that includes a capability set identifier identifying a capability set of the one or more capability sets of the capability value set list; and
transmitting a feedback message indicating whether the CSI report is successfully received and whether to retransmit information identifying the capability set identifier.

35. The method of claim 34, further comprising:
scheduling a transmission in accordance with the reported capability value set based at least in part on successfully receiving the CSI report.
